(19) United States
(12) Patent Application Publication
(10) Pub. No.: US 2008/0212585 A1
(43) Pub. Date: Sep. 4, 2008

(54) Preventing Loops during Recovery in Network Rings Using Cost Metric Routing Protocol

(76) Inventors: Russell White, Holly Springs, NC (US); Steven Moore, Holly Springs, NC (US); James Ng, Mebane, NC (US); Yi Yang, Morrisville, NC (US)

Correspondence Address: Eugene Molinelli;Evans & Molinelli PLLC, P.O. Box 7024, Fairfax Station, VA, 22039, US

(21) Appl. No.: 11/681,001

(22) Filed: Mar. 1, 2007

(51) Int. Cl. H04L 12/56

(52) U.S. Cl. 370/392

(57) ABSTRACT

In one embodiment, a method includes receiving advertised costs to reach a destination address from neighbor routers. Based on the advertised costs, a minimum first cost to reach the destination address from the local router through the neighbors is determined. The first cost corresponds to a successor among the neighbors. Also determined is a minimum second cost of the advertised costs excluding only an advertised cost from the successor. The second cost corresponds to a second router. If it is determined that communication with the successor is interrupted, and the second cost is not less than the first cost, then it is determined whether the second cost is equal to the first cost. If so, then a data packet, which is directed to the destination address and received from a neighbor that is different from the second router, is forwarded to the second router.

### BACKGROUND OF THE INVENTION

1. Field of the Invention

The present invention relates to routing data packets in packet-switched communication networks.

2. Description of the Related Art

Networks of general purpose computer systems and specialized devices connected by external communication links are well known and widely used in commerce. The networks often include one or more network devices that facilitate the passage of information between the computer systems and devices. A network node is a network device or computer or specialized device connected by the communication links. An end node is a node that is configured to originate or terminate communications over the network. An intermediate network node facilitates the passage of data between end nodes.

Communications between nodes are typically effected by exchanging discrete packets of data. Information is exchanged within data packets according to one or more of many well known, new or still developing protocols. In this context, a protocol consists of a set of rules defining how the nodes interact with each other based on information sent over the communication links. Each packet typically comprises 1] header information associated with a particular protocol, and 2] payload information that follows the header information and contains information that may be processed independently of that particular protocol. The header includes information such as the source of the packet, its destination, the length of the payload, and other properties used by the protocol. Often, the data in the payload for the particular protocol includes a header and payload for a different protocol associated with a different layer of detail for information exchange.

Intermediate network nodes called routers maintain routing information that indicates which communication links to use to forward data packets directed to particular destination addresses in a network. When a link goes down, the routers communicate with each other in a recovery process to determine a different link that is best used to forward the data packets formerly forwarded over the link that went down. Some data packets may be lost during the recovery process. Thus, it is often desirable to intelligently forward data packets during the recovery process so that the number of data packets lost during recovery is reduced.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example network that includes multiple routers;

FIG. 2A illustrates an example control plane message for a routing protocol;

FIG. 2B illustrates an example router that forwards data packets during recovery of a lost route;

FIG. 3 illustrates at a high level an example method for forwarding data packets during recovery of a lost route; and

FIG. 4 illustrates an example computer system upon which an embodiment of the invention may be implemented.

### DESCRIPTION OF EXAMPLE EMBODIMENTS

Techniques are described for preventing loops when forwarding data packets during recovery of lost routes. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In the following description, embodiments of the invention are described in the context of EIGRP as a routing protocol. However, the invention is not limited to this context and protocol, but may be applied in any routing protocol that sends summary information including destination addresses and cost metrics in update messages.

### 1.0 Overview

In one set of embodiments, a method includes receiving data that indicates advertised costs to reach a destination address from corresponding neighbor routers of a local router. Based on the advertised costs, a minimum first cost is determined to reach the destination address from the local router through a successor router among the neighbor routers. A minimum second cost is determined of the advertised costs excluding only an advertised cost from the successor router. The second cost corresponds to a second router among the neighbor routers, which is not the successor router. It is determined whether communication with the successor router is interrupted; and, if so, then the destination address is marked as undergoing repair at the local router. If the second cost is not less than the first cost while the destination is under repair; then it is determined whether the second cost is equal to the first cost. If so, then a data packet directed to the destination address received from a neighbor other than the second router is forwarded to the second router.

In other sets of embodiments, an apparatus or logic encoded in a tangible medium performs one or more steps of the above method.

### 2.0 Network Overview

The headers included in a packet traversing multiple heterogeneous networks, such as the Internet, typically include a physical (layer 1) header, a data-link (layer 2) header, an internetwork (layer 3) header and a transport (layer 4) header, as defined by the Open Systems Interconnection (OSI) Reference Model. The OSI Reference Model is generally described in more detail in Section 1.1 of the reference book entitled Interconnections Second Edition, by Radia Perlman, published September 1999, which is hereby incorporated by reference as though fully set forth herein.

The internetwork header provides information defining the source and destination address within the network. Notably, the path may span multiple physical links. The internetwork header may be formatted according to the Internet Protocol (IP), which specifies IP addresses of both a source and destination node at the end points of the logical path. Thus, the packet may “hop” from node to node along its logical path until it reaches the end node assigned to the destination IP address stored in the packet's internetwork header.

Routers and switches are intermediate network nodes that determine which communication link or links to employ to support the progress of data packets through the network. A network node that determines which links to employ based on information in the internetwork header (layer 3) is called a router.

Some protocols pass protocol-related information among two or more network nodes in special control packets that are communicated separately and which include a payload of information used by the protocol itself rather than a payload of data to be communicated for another application. These control packets and the processes at network nodes that utilize the control packets are said to be in another dimension, a “control plane,” distinct from the “data plane” dimension that includes the data packets with payloads for other applications at the end nodes.

A routing protocol only exchanges control plane messages used for routing data packets sent in a different routed protocol (e.g., IP). Example routing protocols include the link state protocols such as the intermediate system to intermediate system (IS-IS) protocol and the open shortest path first (OSPF) protocol. Another routing protocol, developed by Cisco Systems of San Jose, Calif. for use in its routers, is the Enhanced Interior Gateway Routing Protocol (EIGRP). Some of the link-state protocols flood all data for a unified routing database within an area and compute best paths using the same process at each router. Some distance-based routing protocols, like EIGRP, send only summary information from each intermediate node.

The summary routing information includes for each destination node identified by an address or range of addresses, a measure of the cost (called a cost metric) to reach those addresses from the intermediate node (e.g., router) providing the summary information. Metrics of cost to traverse links in a network are well known in the art. A router receives such summary routing information from each neighboring router (neighbor) with which the router shares a direct communications link. The receiving router then determines the route (i.e., the best next hop, also called the best “path” herein) based on the cost metrics reported by all the neighbors and the costs to traverse the link to reach each of those neighbors.

In a current approach, when a router loses a route to a particular destination, and has a record in storage for an alternative path that is loop-free, the router replaces the next hop with the alternative loop free path immediately, and does not drop data packets directed to that destination. A loop-free path from a particular router is one in which the next hop goes to a router that is closer to the destination than the particular router itself. If the next hop goes to a farther router, subsequent hops possibly come back to the particular router, thus forming a loop. If the next hop goes to an equally far router, it is possible that, after the current next hop fails, a subsequent hop comes back to the particular router; thus forming a loop. When a router loses a route to a particular destination, and does not have a record in storage for an alternative path that is loop-free, the router sends a query to each neighbor, asking for the neighbor's routes and costs to the particular destination as part of a recovery process. A new route is determined based on the responses to the queries during the recovery process. However, many data packets directed to the destination may be dropped during the recovery process.

According to the illustrated embodiment, when a neighbor of a particular router has equal cost to reach a destination, that neighbor is considered a temporary next hop for traffic to that destination during the recovery process. Traffic is monitored to prevent a loop, but in cases in which a loop is not formed, this approach does not drop data packets during the recovery process. Example benefits of such a process are demonstrated in an example network.

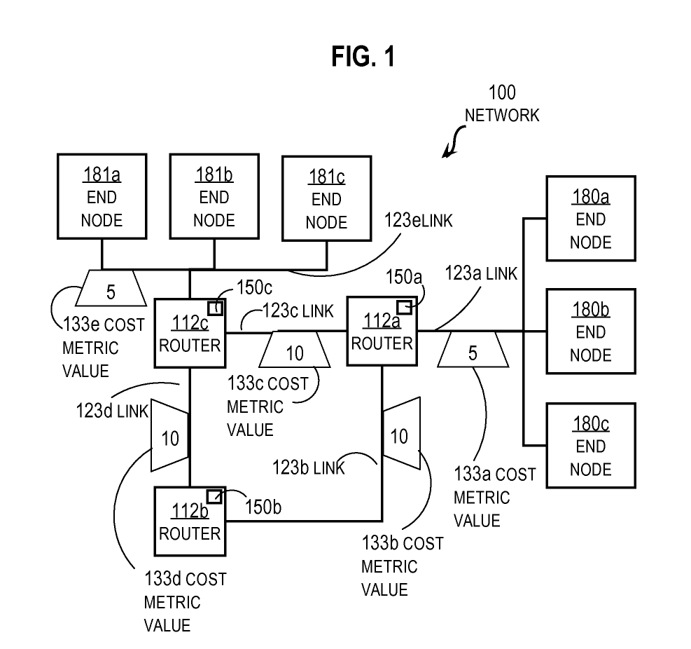

FIG. 1 illustrates an example network 100 that includes multiple routers. Network 100 includes three intermediate network nodes: router 112a, router 112b, and router 112c, collectively referenced hereinafter as routers 112. Network 100 also includes end node 180a, end node 180b, end node 180c (collectively referenced hereinafter as end nodes 180), end node 181a, end node 181b and end node 181c (collectively referenced hereinafter as end nodes 181). The routers 112 and end nodes 180, 181 are connected by five communication links: link 123a, link 123b, link 123c, link 123d and link 123e, collectively referenced hereinafter as links 123. Also shown in FIG. 1 is a cost metric value associated with each link. A cost metric value represents a property of a link and is not a separate physical component of network 100. Five cost metric values are shown: cost metric value 133a, cost metric value 133b, cost metric value 133c, cost metric value 133d and cost metric value 133e (collectively referenced hereinafter as costs 133) associated with link 123a, link 123b, link 123c, link 123d and link 123e, respectively.

In the illustrated embodiment, router 112a, router 112b and router 112c include loop-free recovery forwarding (LFRF) process 150a, LFRF process 150b, and LFRF process 150c, respectively, collectively referenced hereinafter as LFRF process 150.

While a certain number of nodes 112, LFRF processes 150, links 123 and end nodes 180, 181 are depicted in network 100 for purposes of illustration, in other embodiments, a network includes more nodes, such as routers with LFRF processes, more links, with the same or different costs 133, and more end nodes. Network 100 has ring structure, because the routers are connected in a ring.

Any method known in the art may be used to determine a cost metric value for a link. For example, in some embodiments a cost on a link is given approximately by Equation 1, which is an approximation of a more comprehensive cost metric that includes seven terms.

Cost metric=bandwidth*10⁻⁷+(sum of link travel time delays)*256 (1)

Using the costs depicted in FIG. 1, Table 1 lists the cost of using the best links and neighbors to reach the end nodes 180 from each router 112. Cost is given in arbitrary units.

TABLE 1
Example costs for the lowest cost path from routers 112 to end
nodes 180 as depicted in FIG. 1

| Local router | Neighbor router | # hops | Cost |
|---|---|---|---|
| 112a | — | 1 | 5 |
| 112b | 112a | 2 | 15 |
| 112c | 112a | 2 | 15 |

The routes of Table 1 are constructed based on control plane messages for a metric-based routing protocol, such as EIGRP. For example, router 112a determines a cost of 5 to reach end node 180 and advertises this in control plane messages to each of its neighbors: router 112b and router 112c on link 123b and link 123c, respectively. Those control plane messages each includes the network address range of end nodes 180 and the reported cost 5 of reaching end nodes 180 as reported by the advertising router 112a. For purposes of illustration, it is assumed that the network addresses of end nodes 180 are represented by the IP version 4 (IPv4) subnet 10.1.1.0/24. An IPv4 address consists of four binary octets. Each binary octet includes eight binary digits (bits) and represents a decimal value from 0 through 255, inclusive. By convention, an IPv4 address is presented as four decimal values separated by dots. A range of contiguous addresses, called a subnet, shares the leading bits called a mask. The number of leading bits in the mask is indicated by a decimal number after a slash. Thus, the example address 10.1.1.0/24 indicates a range of addresses that share the first 24 bits, e.g., 10.1.1.0 through 10.1.1.255, inclusive. For purposes of illustration, it is further assumed that the network addresses of end nodes 181 are represented by the IPv4 subnet 10.1.5.0/24.

At receiving router 112b and router 112c, each router adds the cost of traversing the link between itself and router 112a to determine the total cost of using that link. Thus router 112b adds link cost 10 of link 123b for a total cost of 15; router 112c adds link cost 10 of link 123c for a total cost of 15. The process continues until the cost of reaching end nodes 180 is known by all routers for all neighbors. Based on the cost of these links, the best path from router 112c to end nodes 180 goes through router 112a rather than through router 112b, as shown in Table 1.

In EIGRP, the neighboring router that provides the best path to a destination is called the successor. Thus router 112a has no successor to end nodes 180, but connects directly to end nodes 180 on subnet 10.1.1.0/24. Router 112a is the successor for both router 112b and router 112c to reach the end nodes 180 on subnet 10.1.1.0/24.

In EIGRP, a definitely loop-free alternative neighbor to the successor is called a feasible successor. In the illustrated embodiment, there is not a feasible successor at routers 112, because there is no neighboring router that has advertised a cost less than the cost through the successor to reach the destination end nodes 180 on subnet 10.1.1.0/24. Considering router 112b, the successor is router 112a that advertises a cost of 5 to reach end nodes 180 on subnet 10.1.1.0/24. The cost to reach end nodes 180 from router 112b through its successor is 15. Router 112b receives an advertisement from router 112c advertising a cost of 15. Since the cost 15 advertised by router 112c is not less than router 112b's own total cost of 15, router 112c is not guaranteed to be loop free upon failure of the link to router 112a, and router 112c is not a feasible successor at router 112b for subnet 10.1.1.0/24. Similarly, router 112b is not a feasible successor at router 112c for subnet 10.1.1.0/24. Note that if cost 133c were 15 instead of 10, then router 112b would be a feasible successor at router 112c for subnet 10.1.1.0/24; and router 112c would not be a feasible successor at router 112b for subnet 10.1.1.0/24.

When the link between 123c goes down, router 112c loses its successor to the end nodes 180 on subnet 10.1.1.0/24. Because router 112c has no feasible successor, it can not automatically replace the lost successor with a feasible successor. Instead, the router 112c marks the destinations 10.1.1.0/24 as active (i.e., a route to those destinations is being actively sought) and sends a control message called a query to router 112b asking for a current path to those destinations. Until router 112c receives an update message from neighbor 112b, router 112c drops data packets directed to destinations in subnet 10.1.1.0/24, such as end nodes 180.

Because network 100 is a ring, when one link between routers goes down, there must be another route to the destination subnet, as long as no router goes down. Thus it would be preferable that router 112c not drop data packets for the end nodes 180, but automatically forward the data packets to router 112b. Router 112b still has a successor in place for subnet 10.1.1.0/24, so any data packets received from router 112c would automatically be sent on to subnet 10.1.1.0/24 through router 112a, even before router 112c receives a response to its query. Router 112c can deduce that router 112b has a useful link as long as the advertised cost from router 112b to the destination subnet 10.1.1.0/24 is equal to the original cost from router 112c and not greater.

Thus in some embodiments, a router that has a neighbor that has advertised a cost to a destination that equals the router's own cost is considered a possible feasible successor (PFS) for that destination. Referring to Table 1, it can be seen that router 112b (that advertises a cost of 15 to subnet 10.1.1.0/24) is a PFS at router 112c (that also advertises a cost of 15 to subnet 10.1.1.0/24, based on link 123c to successor router 112a). Similarly, router 112c is a PFS to subnet 10.1.1.0/24 at router 112b, because both neighbors advertise an equal cost of 15 to subnet 10.1.1.0/24.

While suitable during recovery for many failure circumstances, forwarding data packets to a PFS during recovery can lead to loops in some failure circumstances. To illustrate such a circumstance, it is assumed that router 112a goes down instead of just link 123c going down. Because router 112c has a PFS in router 112b, when router 112a fails, router 112c sends a query to router 112b and begins forwarding data packets addressed to end nodes 180 to PFS router 112b. Because router 112b also has a PFS in router 112c, when router 112a fails, router 112b sends a query to router 112c and begins forwarding data packets addressed to end nodes 180 to PFS router 112c. Without a mechanism to prevent it, router 112c will forward data packets addressed to end nodes 180 and received from router 112b back to router 112b, thus forming a loop. Similarly, router 112b will forward data packets addressed to end nodes 180 and received from router 112c back to router 112c, including any data packets it already sent to router 112c, thus forming a loop. Such a loop not only wastes network resources; but, can lead to failure of router 112b or router 112c or both.

According to an illustrated embodiment, the process 150 forwards data packets to a PFS during recovery by installing a reverse discard route in routing tables used by routers 112 so that any data packets received from a PFS router are not forwarded back to that PFS router. In other embodiments, other mechanisms are used to prevent forwarding data packets to a PFS that were received from that PFS.

### 3.0 Structural Overview

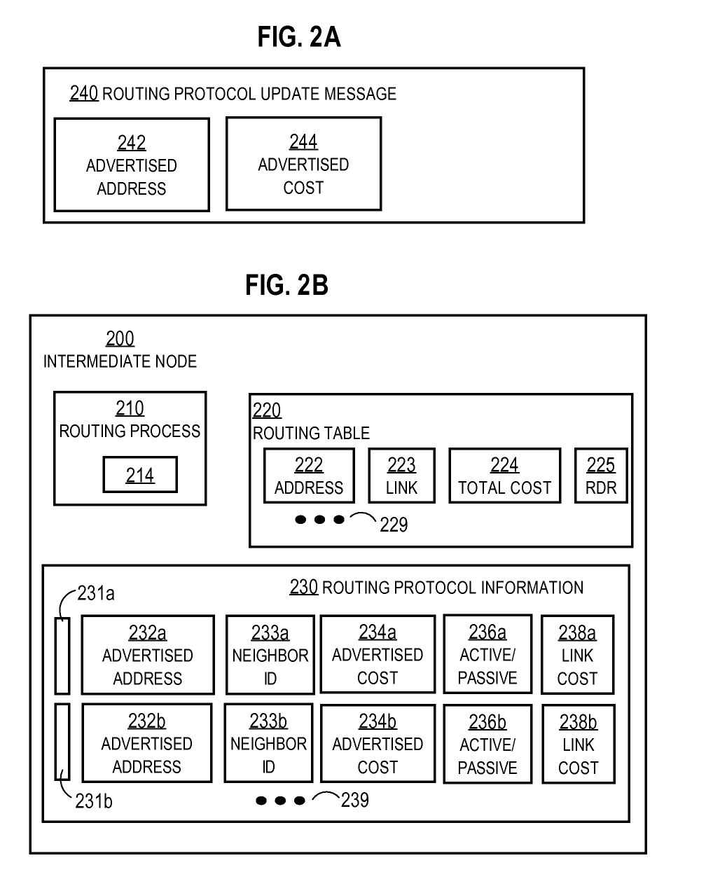

FIG. 2A illustrates an example control plane message 240 for a routing protocol. Control plane message 240 includes an advertised address field 242 and an advertised cost field 244. The advertised address field 242 holds data that indicates an address or subnet that can be reached by the advertising router. The advertised cost field 244 holds data that indicates cast to reach the address or subnet from the advertising router

FIG. 2B illustrates an example router 200 that forwards data packets during recovery of a lost route. Router 200 includes a routing process 210, a routing table 220, and routing protocol information 230.

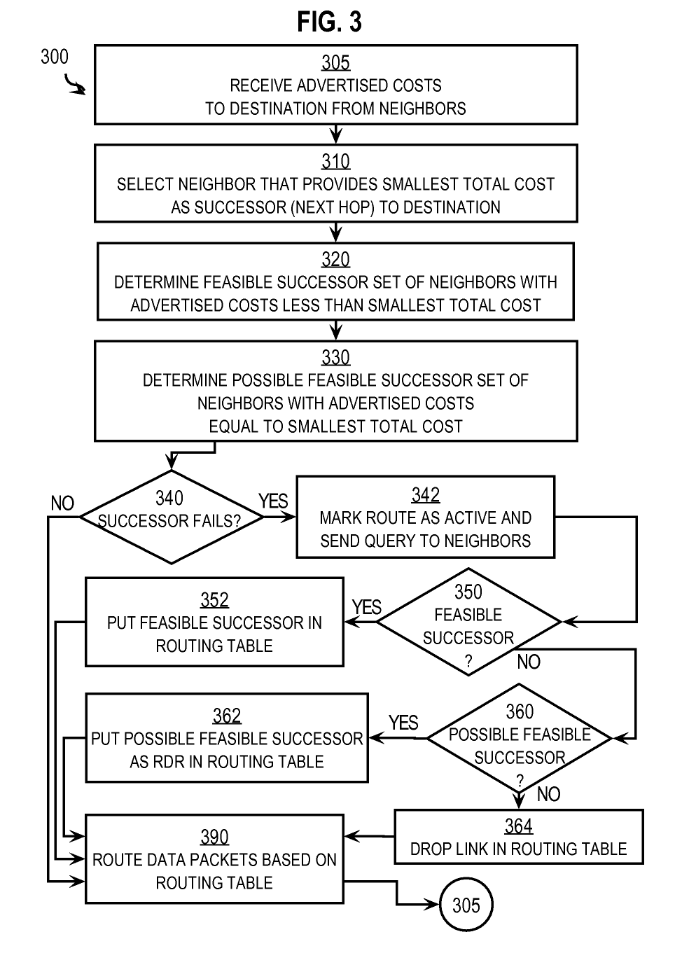

The routing process 210 executes on a processor, such as a general purpose processor executing sequences of instructions that cause the processor to perform the routing process. According to embodiments of the invention, routing process includes LFRF process 214 to perform loop-free forwarding of data packets during recovery as described in more detail below with respect to FIG. 3. The routing process 210 stores and retrieves information in the routing table 220 based on information received in one or more routing protocol update messages that are stored in a routing protocol information data structure 230.

The routing table 220 is a data structure that includes for each destination that can be reached from the router 200, an address field 222, a link field 223 and zero or more attribute fields. In the illustrated embodiment, the attributes fields include a total cost field 224 and a reverse discard route flag field 225. Fields for other destinations in routing table 220 are indicated by ellipsis 229.

The routing protocol information data structure 230 is a data structure that includes for each destination received in a routing protocol update message an address field (e.g., address fields 232a, 232b, collectively referenced hereinafter as address fields 232); a neighbor identifier (ID) field (e.g., neighbor ID fields 233a, 233b, collectively referenced hereinafter as neighbor ID fields 233); an advertised cost field (e.g., advertised cost fields 234a, 234b, collectively referenced hereinafter as advertised cost fields 234); and an active/passive flag field (e.g., active/passive flag fields 236a, 236b, collectively referenced hereinafter as active/passive flag fields 236). In the illustrated embodiment, data structure 230 also includes link cost fields 238a, 238b (collectively referenced hereinafter as link cost fields 238). In the illustrated embodiment, data structure 230 also includes local successor flag fields 231a, 231b (collectively referenced hereinafter as local successor flag fields 236). Fields for other destinations in routing protocol information data structure 230 are indicated by ellipsis 239.

Data structures may be formed in any method known in the art, including using portions of volatile memory, or non-volatile storage on one or more nodes, in one or more files or in one or more databases accessed through a database server, or some combination. Although data structures 220, 230 are shown as integral blocks with contiguous fields, e.g. fields 232, for purposes of illustration, in other embodiments one or more portions of fields and data structures 220, 230 are stored as separate data structures on the same or different multiple nodes that perform the functions of router 200.

The advertised address field holds data that indicates a network address, such as the IP address, of a particular end node or subnet (e.g., 10.1.1.0/24 for end nodes 180) of the network (e.g., network 100). The neighbor ID field 233 holds data that indicates the neighbor from which (or the link over which) information about the associated advertised address was received. An IP address of the neighbor or a network interface connected to the neighbor, or some other ID is used in various embodiments. The advertised cost field 234 holds data that indicates the cost to reach the associated advertised address indicated by the neighbor. The link cost field 238 holds data that indicates the cost to traverse the link between the local router and the neighbor (e.g., 10 to traverse the link 123c between router 112c and router 112a). The active/passive flag field 236 holds data that indicates that the cost or advertised address or link to the neighbor is active (e.g., being updated and can not be relied upon as currently correct) or passive (correct and not being updated). If the neighbor did not advertise a route to the associated advertised address, the reported cost field 234 holds a default or null value, such as the maximum cost value available for the cost metric, or the active/passive flag field holds data that indicates the record is active. Fields 232, 233, 234 and 236 are included in data structure 230 in conventional cost-based routing protocols, such as EIGRP.

According to various embodiments of the invention, routing protocol information data structure 230 includes local successor flag field 231. Local successor flag field 231 indicates whether the associated neighbor or link indicated in neighbor ID field 233 is a feasible successor with a loop-free path from the local router 200 to the associated advertised address in field 232 or is a possible feasible successor (PFS). As described in more detail below, this can be determined from the current total cost of reaching the address in the routing table 220 and the advertised cost in field 234 of the neighbor indicated in field 233. If the advertised cost is less than the current total cost, then that neighbor is a feasible successor for the local router 200. If the advertised cost is equal to the current total cost, then that neighbor is a PFS for the local router 200. If the advertised cost is greater than the current total cost, then that neighbor is neither a feasible successor nor a PFS for the local router 200. For example, the flag 231 is a 2 bit field that is 01 to indicate feasible successor, 11 to indicate PFS and 00 to indicate neither. If there is more than one feasible successor for a particular address or subnet, then the link to the feasible successor with the lowest total cost is placed in the routing table 220 in association with the address. In some embodiments, the feasible successor that is used as the successor is marked with a different value in flag field 231, e.g., a binary 10.

### 4.0 Method for Recovery of Lost Route

FIG. 3 illustrates at a high level an example method for forwarding data packets during recovery of a lost route. Although steps in FIG. 3 are shown in a particular order for purposes of illustration, in other embodiments one or more steps may be performed in a different order or overlapping in time, in series or in parallel, or one or more steps may be omitted or added, or some combination of changes may be made.

In step 305, a local router receives routing protocol update messages that indicate advertised costs to reach destination addresses from neighboring routers. A neighboring router (neighbor) is a router that is connected directly on a communication link without an intervening router.

For example, local router 112c receives a control packet formatted as message 240 from router 112a that indicates subnet 10.1.1.0/24 can be reached from router 112a with an advertised cost of 5. Data indicating the advertised address 10.1.1.0/24 is placed in field 232a, data indicating the ID for router 112a is placed in field 233a, and data indicating the value 5 is placed in field 234a. Data indicating the connection is passive (currently correct) is placed in field 236a. Router 112c also determines the cost over link 123c with router 112a is 10 and places data that indicates the value 10 into field 238a. In some embodiments this determination is made during step 305; and in some embodiments, this determination is made in a different step. Similarly, local router 112c receives a control packet formatted as message 240 from router 112b that indicates subnet 10.1.1.0/24 can be reached from router 112b with an advertised cost of 15. Data indicating the advertised address 10.1.1.0/24 is placed in field 232b, data indicating the ID for router 112b is placed in field 233b, and data indicating the value 15 is placed in field 234b. Data indicating the connection is passive (currently correct) is placed in field 236b. Router 112c also determines the cost over link 123d with router 112b is 10 and places data that indicates the value 10 into field 238b. Table 2 shows the contents of routing protocol information data structure 230 at router 112c after receiving both these update messages.

TABLE 2
Example Routing Protocol Information at first time.

| Field | First neighbor | Second neighbor |
|---|---|---|
| Successor flag | — | — |
| advertised address | 10.1.1.0/24 | 10.1.1.0/24 |
| neighbor ID | 112a | 112b |
| advertised cost | 5 | 15 |
| active/passive | passive | passive |
| link cost | 10 | 10 |

In step 310, the neighbor that provides the smallest total cost by adding the values indicated by data in the advertised cost field 234 and the link cost field 238, is selected as a successor (next hop) for each destination. For example, at router 112c using Table 2, a next hop through router 112a has a total cost of 15 for the destinations 10.1.1.0/24 and a next hop through router 112b has a total cost of 25. Therefore, a next hop to router 112a has a minimum cost; and router 112a is selected as the successor for router 112c. If more than one has the same minimum, then one is selected using some tie-breaking procedure, e.g., selecting the router with the smallest router ID. The advertised address is associated with a link to the successor and the total cost in a routing table. For example, data indicating the subnet 10.1.1.0/24 is put into field 222, an identifier for the network interface to link 123c with router 112a is placed into field 223, and data that indicates the total cost of 15 is placed into field 224. The RDR flag field 225 is set to zero (or left with a default value of zero) to indicate that the route to this destination is not a reverse discard route. The contents of this portion of the routing table are listed in Table 3. The successor flag field 231 in the routing protocol information data structure is set to indicate that neighbor 112a is the successor.

TABLE 3
Example contents of routing table at first time.

| Field name | Value indicated |
|---|---|
| address | 10.1.1.0/24 |
| link | 123c |
| total cost | 15 |
| reverse discard route flag | no |

In step 320, any neighbor that has an advertised cost to the destination less than the smallest total cost to the destination is selected as a feasible successor. For example, any neighbor with an advertised cost less than 15 is selected as a feasible successor. In the example of router 112c depicted in Table 2, no neighbor advertises a cost less than 15 and therefore no neighbor is a feasible successor. If link 123b had a cost metric value 133b of 7 instead of 10, then the advertised cost from router 112b would have been 7+5=12 and router 112b would have been a feasible successor. The successor flag field 231 in the routing protocol information data structure is set to indicate that neighbor is a feasible successor.

In step 330, any neighbor that has an advertised cost to the destination equal to the smallest total cost to the destination is selected as a possible feasible successor (PFS). For example, at router 112c using Table 2, any neighbor with an advertised cost equal to 15 is selected as a PFS. In the illustrated example, router 112b advertises a cost equal to 15 and therefore router 112b is a PFS. The successor flag field 231 in the routing protocol information data structure is set to indicate that neighbor is a possible feasible successor. In the illustrated example, a portion of the contents of the routing protocol information data structure 230 is as listed in Table 4.

TABLE 4
Example Routing Protocol Information at later time.

| Field | First neighbor | Second neighbor |
|---|---|---|
| Successor flag | successor | possible feasible successor |
| advertised address | 10.1.1.0/24 | 10.1.1.0/24 |
| neighbor ID | 112a | 112b |
| advertised cost | 5 | 15 |
| active/passive | passive | passive |
| link cost | 10 | 10 |

In step 340, it is determined whether communication with the successor fails. This failure can be due to link failure, such as a damaged or broken cable or wireless card, or router failure, such as a damaged or removed router. If a previous failure has just been repaired, step 340 includes determining that the failure has ended and updating the routing table with the repaired routes. If there is no new failure, or a previous failure has been repaired, then control passes to step 390.

In step 390, the router continues to route data packets based on the routing table (e.g., according to the contents of Table 3, above). Step 390 includes passing control to step 305 when a routing update message is received.

If it is determined, during step 340, that communication with the successor has newly failed, control passes to step 342. For purposes of illustration it is assumed that router 112a is newly damaged and has just become unable to communicate with router 112b or router 112c. In the illustrated example, this failure is detected at router 112c during step 340.

In step 342, the destination using the failed communication link is marked active, and a query is sent to one or more neighbors to seek a new route to the destination. For example, the contents of the routing protocol information data structure 230 is revised to insert data indicating “active” in field 236a, as shown in Table 5, below. In some embodiments, a null or special value for the successor flag is inserted in field 231a, or a null or special value for the advertised cost is inserted in field 234a, or a null or special value for the link cost is inserted into field 238a, or some combination, instead of or in addition to inserting data indicating active in field 236a

TABLE 5
Example Routing Protocol Information at time after failure.

| Field | First neighbor | Second neighbor |
|---|---|---|
| Successor flag | successor | possible feasible successor |
| advertised address | 10.1.1.0/24 | 10.1.1.0/24 |
| neighbor ID | 112a | 112b |
| advertised cost | 5 | 15 |
| active/passive | active | passive |
| link cost | 10 | 10 |

In step 350, it is determined whether there is a feasible successor to the destination. If so, then control passes to step 352. In step 352, one of the feasible successors, which provides a minimum total cost, is selected as a successor (next hop) for the destination. If more than one of the feasible successors have the same minimum, then one is selected using some tie-breaking procedure, e.g., selecting the router with the smallest router ID. The advertised address of the selected feasible successor is associated with a link to the selected feasible successor and the total cost in the routing table. Control then passes to step 390 to route data packets based on the routing table.

If it is determined, in step 350, that there is not a feasible successor to the destination, then control passes to step 360. In step 360, it is determined whether there is a possible feasible successor (PFS) to the destination. If so, then control passes to step 362. In step 362, one of the PFS, which provides a minimum total cost, is selected as a successor (next hop) for the destination. If more than one of the PFS have the same minimum, then one is selected using some tie-breaking procedure, e.g., selecting the PFS with the smallest router ID. The advertised address is associated with a link to the PFS and the total cost in the routing table. For example, an identifier for the network interface to link 123d with the PFS (router 112b) is placed into field 223, and data that indicates the total cost of 25 is placed into field 224. The RDR flag field 225 is set to one to indicate that the route to this destination is a reverse discard route. The contents of this portion of the routing table are listed in Table 6.

TABLE 6
Example contents of routing table at time after failure.

| Field name | Value indicated |
|---|---|
| address | 10.1.1.0/24 |
| link | 123d |
| total cost | 25 |
| reverse discard route flag | yes |

Control then passes to step 390 to route data packets based on the routing table.

In step 390, data packets directed to the destination but received on the link marked RDR are not forwarded to the link marked RDR. This prevents looping, such as when router 112a has failed. Other data packets directed to the destination, and not received over the link marked RDR, are forwarded to the link marked RDR. Thus data packets directed to 10.1.1.0 and received over link 123d (from router 112b) are not forwarded over link 123d. Thus data packets directed to 10.1.1.0 and received over link 123e (from end nodes 181) are forwarded over link 123d.

If it is determined, in step 360, that there is not a PFS to the destination, then control passes to step 364. In step 364, the advertised address is associated with a special value that indicates dropping the data packets. For example, the special value is placed into field 223, and a null value is placed into field 224. The RDR flag field 225 is not set. The contents of this portion of the routing table are listed in Table 7.

TABLE 7
Example contents of routing table at after failure with no PFS.

| Field name | Value indicated |
|---|---|
| address | 10.1.1.0/24 |
| link | drop packets |
| total cost | null |
| reverse discard route flag | no |

In the illustrated example with a PFS inserted into field 223, as listed in Table 5, if only link 123c is down, the data packets directed to 10.1.1.0/24 are forwarded to router 112b. Router 112b still has its link 123b with router 112a and those data packets are forwarded from router 112b to router 112a. Thus these data packets arrive at their destination during recovery while the router 112c seeks a better route, if any, to the destination in response to the query messages sent.

However, if router 112a goes down, both routers 112b and 112c have each other as a PFS and each forwards data packets to the other. Because each also marks the forwarded link as a reverse discard route (RDR), packets forwarded to router 112c from router 112b are not sent back to router 112b, and packets forwarded to router 112b from router 112c are not sent back to router 112c. Thus method 300 avoids a loop in a ring network during recovery.

### 5.0 Implementation Mechanisms—Hardware Overview

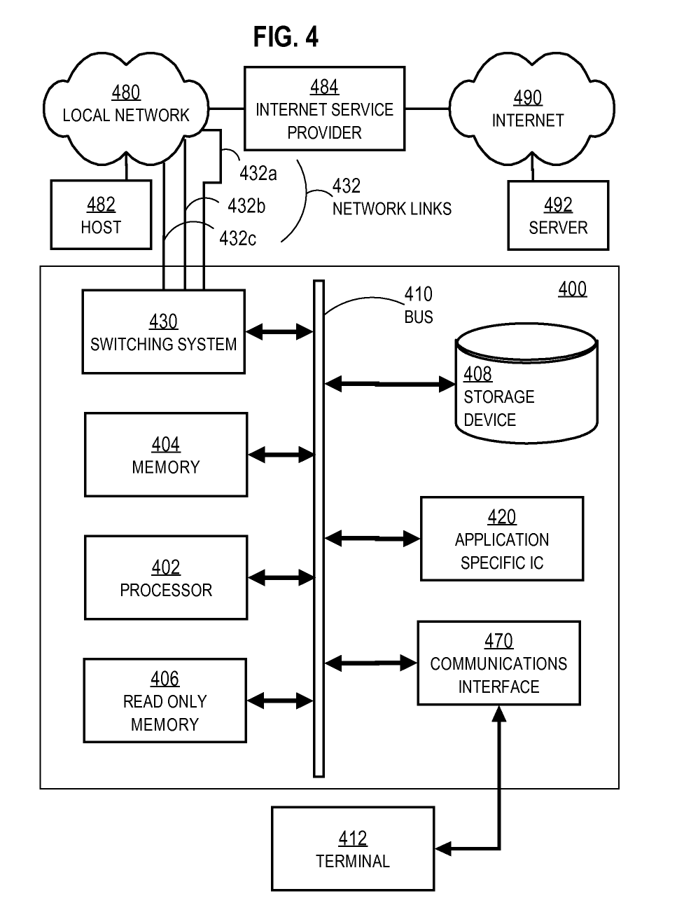

FIG. 4 illustrates a computer system 400 upon which an embodiment of the invention may be implemented. The preferred embodiment is implemented using one or more computer programs running on a network element such as a router device. Thus, in this embodiment, the computer system 400 is a router.

Computer system 400 includes a communication mechanism such as a bus 410 for passing information between other internal and external components of the computer system 400. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). A sequence of binary digits constitutes digital data that is used to represent a number or code for a character. A bus 410 includes many parallel conductors of information so that information is transferred quickly among devices coupled to the bus 410. One or more processors 402 for processing information are coupled with the bus 410. A processor 402 performs a set of operations on information. The set of operations include bringing information in from the bus 410 and placing information on the bus 410. The set of operations also typically include comparing two or more units of information, shifting positions of units of information, and combining two or more units of information, such as by addition or multiplication. A sequence of operations to be executed by the processor 402 constitute computer instructions.

Computer system 400 also includes a memory 404 coupled to bus 410. The memory 404, such as a random access memory (RAM) or other dynamic storage device, stores information including computer instructions. Dynamic memory allows information stored therein to be changed by the computer system 400. RAM allows a unit of information stored at a location called a memory address to be stored and retrieved independently of information at neighboring addresses. The memory 404 is also used by the processor 402 to store temporary values during execution of computer instructions. The computer system 400 also includes a read only memory (ROM) 406 or other static storage device coupled to the bus 410 for storing static information, including instructions, that is not changed by the computer system 400. Also coupled to bus 410 is a non-volatile (persistent) storage device 408, such as a magnetic disk or optical disk, for storing information, including instructions, that persists even when the computer system 400 is turned off or otherwise loses power.

The term computer-readable medium is used herein to refer to any medium that participates in providing information to processor 402, including instructions for execution. Such a medium may take many forms, including, but not limited to, non-volatile media, volatile media and transmission media. Non-volatile media include, for example, optical or magnetic disks, such as storage device 408. Volatile media include, for example, dynamic memory 404. Transmission media include, for example, coaxial cables, copper wire, fiber optic cables, and waves that travel through space without wires or cables, such as acoustic waves and electromagnetic waves, including radio, optical and infrared waves. Signals that are transmitted over transmission media are herein called carrier waves.

Common forms of computer-readable media include, for example, a floppy disk, a flexible disk, a hard disk, a magnetic tape or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read.

Information, including instructions, is provided to the bus 410 for use by the processor from an external terminal 412, such as a terminal with a keyboard containing alphanumeric keys operated by a human user, or a sensor. A sensor detects conditions in its vicinity and transforms those detections into signals compatible with the signals used to represent information in computer system 400. Other external components of terminal 412 coupled to bus 410, used primarily for interacting with humans, include a display device, such as a cathode ray tube (CRT) or a liquid crystal display (LCD) or a plasma screen, for presenting images, and a pointing device, such as a mouse or a trackball or cursor direction keys, for controlling a position of a small cursor image presented on the display and issuing commands associated with graphical elements presented on the display of terminal 412. In some embodiments, terminal 412 is omitted.

Computer system 400 also includes one or more instances of a communications interface 470 coupled to bus 410. Communication interface 470 provides a two-way communication coupling to a variety of external devices that operate with their own processors, such as printers, scanners, external disks, and terminal 412. Firmware or software running in the computer system 400 provides a terminal interface or character-based command interface so that external commands can be given to the computer system. For example, communication interface 470 may be a parallel port or a serial port such as an RS-232 or RS-422 interface, or a universal serial bus (USB) port on a personal computer. In some embodiments, communications interface 470 is an integrated services digital network (ISDN) card or a digital subscriber line (DSL) card or a telephone modem that provides an information communication connection to a corresponding type of telephone line. In some embodiments, a communication interface 470 is a cable modem that converts signals on bus 410 into signals for a communication connection over a coaxial cable or into optical signals for a communication connection over a fiber optic cable. As another example, communications interface 470 may be a local area network (LAN) card to provide a data communication connection to a compatible LAN, such as Ethernet. Wireless links may also be implemented. For wireless links, the communications interface 470 sends and receives electrical, acoustic or electromagnetic signals, including infrared and optical signals, which carry information streams, such as digital data. Such signals are examples of carrier waves

In the illustrated embodiment, special purpose hardware, such as an application specific integrated circuit (IC) 420, is coupled to bus 410. The special purpose hardware is configured to perform operations not performed by processor 402 quickly enough for special purposes. Examples of application specific ICs include graphics accelerator cards for generating images for display, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware. Logic encoded in one or more tangible media includes one or both of computer instructions and special purpose hardware.

In the illustrated computer used as a router, the computer system 400 includes switching system 430 as special purpose hardware for switching information for flow over a network. Switching system 430 typically includes multiple communications interfaces, such as communications interface 470, for coupling to multiple other devices. In general, each coupling is with a network link 432 that is connected to another device in or attached to a network, such as local network 480 in the illustrated embodiment, to which a variety of external devices with their own processors are connected. In some embodiments an input interface or an output interface or both are linked to each of one or more external network elements. Although three network links 432a, 432b, 432c are included in network links 432 in the illustrated embodiment, in other embodiments, more or fewer links are connected to switching system 430. Network links 432 typically provides information communication through one or more networks to other devices that use or process the information. For example, network link 432b may provide a connection through local network 480 to a host computer 482 or to equipment 484 operated by an Internet Service Provider (ISP). ISP equipment 484 in turn provides data communication services through the public, world-wide packet-switching communication network of networks now commonly referred to as the Internet 490. A computer called a server 492 connected to the Internet provides a service in response to information received over the Internet. For example, server 492 provides routing information for use with switching system 430.

The switching system 430 includes logic and circuitry configured to perform switching functions associated with passing information among elements of network 480, including passing information received along one network link, e.g. 432a, as output on the same or different network link, e.g., 432c. The switching system 430 switches information traffic arriving on an input interface to an output interface according to pre-determined protocols and conventions that are well known. In some embodiments, switching system 430 includes its own processor and memory to perform some of the switching functions in software. In some embodiments, switching system 430 relies on processor 402, memory 404, ROM 406, storage 408, or some combination, to perform one or more switching functions in software. For example, switching system 430, in cooperation with processor 404 implementing a particular protocol, can determine a destination of a packet of data arriving on input interface on link 432a and send it to the correct destination using output interface on link 432c. The destinations may include host 482, server 492, other terminal devices connected to local network 480 or Internet 490, or other routing and switching devices in local network 480 or Internet 490.

The invention is related to the use of computer system 400 for implementing the techniques described herein. According to one embodiment of the invention, those techniques are performed by computer system 400 in response to processor 402 executing one or more sequences of one or more instructions contained in memory 404. Such instructions, also called software and program code, may be read into memory 404 from another computer-readable medium such as storage device 408. Execution of the sequences of instructions contained in memory 404 causes processor 402 to perform the method steps described herein. In alternative embodiments, hardware, such as application specific integrated circuit 420 and circuits in switching system 430, may be used in place of or in combination with software to implement the invention. Thus, embodiments of the invention are not limited to any specific combination of hardware and software.

The signals transmitted over network link 432 and other networks through communications interfaces such as interface 470, which carry information to and from computer system 400, are example forms of carrier waves. Computer system 400 can send and receive information, including program code, through the networks 480, 490 among others, through network links 432 and communications interfaces such as interface 470. In an example using the Internet 490, a server 492 transmits program code for a particular application, requested by a message sent from computer 400, through Internet 490, ISP equipment 484, local network 480 and network link 432b through communications interface in switching system 430. The received code may be executed by processor 402 or switching system 430 as it is received, or may be stored in storage device 408 or other non-volatile storage for later execution, or both. In this manner, computer system 400 may obtain application program code in the form of a carrier wave.

Various forms of computer readable media may be involved in carrying one or more sequence of instructions or data or both to processor 402 for execution. For example, instructions and data may initially be carried on a magnetic disk of a remote computer such as host 482. The remote computer loads the instructions and data into its dynamic memory and sends the instructions and data over a telephone line using a modem. A modem local to the computer system 400 receives the instructions and data on a telephone line and uses an infra-red transmitter to convert the instructions and data to an infra-red signal, a carrier wave serving as the network link 432b. An infrared detector serving as communications interface in switching system 430 receives the instructions and data carried in the infrared signal and places information representing the instructions and data onto bus 410. Bus 410 carries the information to memory 404 from which processor 402 retrieves and executes the instructions using some of the data sent with the instructions. The instructions and data received in memory 404 may optionally be stored on storage device 408, either before or after execution by the processor 402 or switching system 430.

### 6.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method comprising the steps of:
receiving data that indicates a plurality of advertised costs to reach a destination address from a corresponding plurality of neighbor routers that are neighbors of a local router;
based on the plurality of advertised costs, determining a first cost to reach the destination address from the local router through a successor router of the plurality of neighbor routers, wherein a cost to reach the destination address from the local node through a neighbor router that is not the successor router is not less than the first cost;
determining a minimum second cost of the plurality of advertised costs excluding only an advertised cost from the successor router, which second cost corresponds to a second router of the plurality of neighbor routers, whereby the second router is not the successor router;
determining whether communication with the successor router is interrupted; and
if it is determined that communication with the successor router is interrupted, then marking the destination address as undergoing repair at the local router;
determining whether the destination address is undergoing repair at the local router and the second cost is not less than the first cost; and
if is determined that the destination address is undergoing repair at the local router and the second cost is not less than the first cost, then performing the steps of:
determining whether the second cost is equal to the first cost, and
if it is determined that the second cost is equal to the first cost then forwarding to the second router a data packet directed to the destination address and received from a sending node that is a neighbor of the local router and that is different from the second router.

2. A method as recited in claim 1, further comprising, if it is determined that the destination address is undergoing repair and the second cost is equal to the first cost, then dropping a data packet directed to the destination address and received from the second router.

3. A method as recited in claim 1, further comprising:
receiving repair data that indicates the destination address is no longer undergoing repair; and
in response to receiving the repair data marking the destination address as not undergoing repair.

4. A method as recited in claim 1, said step of forwarding to the second router a data packet directed to the destination address and received from the sending node further comprising associating the destination address with a reverse discard route to the second router in a routing table.

5. A method as recited in claim 1, wherein:
the method further comprises, before said step of determining whether communication with the successor neighbor router is interrupted, performing the steps of
determining whether the second cost equal is to the first cost, and
if it is determined that the second cost is equal to the first cost, then associating with the destination address an identifier for the second router and recovery data that indicates a possible loop free alternative during recovery; and
said step of determining whether the second cost is equal to the first cost if it is determined that the destination address is undergoing repair at the local router further comprises determining whether the recovery data associated with the destination address indicates a possible loop free alternative during recovery.

6. An apparatus comprising:
means for receiving data that indicates a plurality of advertised costs to reach a destination address from a corresponding plurality of neighbor routers that are neighbors of a local router;
means for determining, based on the plurality of advertised costs, a first cost to reach the destination address from the local router through a successor router of the plurality of neighbor routers, wherein a cost to reach the destination address from the local node through a neighbor router that is not the successor router is not less than the first cost;
means for determining a minimum second cost of the plurality of advertised costs excluding only an advertised cost from the successor router, which second cost corresponds to a second router of the plurality of neighbor routers, whereby the second router is not the successor router;
means for determining whether communication with the successor router is interrupted; and
means for marking the destination address as undergoing repair at the local router, if it is determined that communication with the successor router is interrupted;
means for determining whether the destination address is undergoing repair at the local router and the second cost is not less than the first cost; and
means for using a possibly loop-free alternative route, if is determined that the destination address is undergoing repair at the local router and the second cost is not less than the first cost, comprising:
means for determining whether the second cost is equal to the first cost, and
means for forwarding to the second router a data packet directed to the destination address and received from a sending node that is a neighbor of the local router and that is different from the second router, if it is determined that the second cost is equal to the first cost.

7. An apparatus as recited in claim 6, wherein the means for using a possibly loop-free alternative route further comprises means for dropping a data packet directed to the destination address and received from the second router if it is determined that the second cost is equal to the first cost.

8. An apparatus as recited in claim 6, further comprising:
means for receiving repair data that indicates the destination address is no longer undergoing repair; and
means for marking the destination address as not undergoing repair in response to receiving the repair data.

9. An apparatus as recited in claim 6, said means for forwarding to the second router a data packet directed to the destination address and received from the sending node further comprising means for associating the destination address with a reverse discard route to the second router in a routing table.

10. An apparatus as recited in claim 6, wherein:
the apparatus further comprises means for determining a possibly loop-free alternative route before determining whether communication with the successor neighbor router is interrupted, said means for determining a possibly loop-free alternative route further comprising
means for determining whether the second cost equal is to the first cost, and
then means for associating with the destination address an identifier for the second router and recovery data that indicates a possible loop free alternative during recovery, if it is determined that the second cost is equal to the first cost; and
said means for determining whether the second cost is equal to the first cost if it is determined that the destination address is undergoing repair at the local router further comprises means for determining whether the recovery data associated with the destination address indicates a possible loop free alternative during recovery.

11. An apparatus comprising:
a plurality of network interfaces that are configured for communicating a data packet with a packet-switched network; and
logic encoded in one or more tangible media for execution and, when executed, operable for:
receiving through the plurality of network interfaces data that indicates a plurality of advertised costs to reach a destination address from a corresponding plurality of neighbor routers connected without an intervening router to the apparatus by the plurality of network interfaces;
based on the plurality of advertised costs, determining a first cost to reach the destination address from the apparatus through a successor router of the plurality of neighbor routers, wherein a cost to reach the destination address from the apparatus through a neighbor router that is not the successor router is not less than the first cost;
determining a minimum second cost of the plurality of advertised costs excluding only an advertised cost from the successor router, which second cost corresponds to a second router of the plurality of neighbor routers, whereby the second router is not the successor router;
determining whether communication with the successor router is interrupted; and
if it is determined that communication with the successor router is interrupted, then marking the destination address as undergoing repair at the apparatus;
determining whether the destination address is undergoing repair at the apparatus and the second cost is not less than the first cost; and
if is determined that the destination address is undergoing repair at the apparatus and the second cost is not less than the first cost, then performing the steps of:
determining whether the second cost is equal to the first cost, and
if it is determined that the second cost is equal to the first cost then forwarding to the second router a data packet directed to the destination address and received from a sending node that is a neighbor of the local router and that is different from the second router.

12. An apparatus as recited in claim 11, wherein, when executed, the logic is further operable for then dropping a data packet directed to the destination address and received from the second router, if it is determined that the destination address is undergoing repair and the second cost is equal to the first cost.

13. An apparatus as recited in claim 11, wherein, when executed, the logic is further operable for:
receiving repair data that indicates the destination address is no longer undergoing repair; and
in response to receiving the repair data marking the destination address as not undergoing repair.

14. An apparatus as recited in claim 11, said forwarding to the second router a data packet directed to the destination address and received from the sending node further comprising associating the destination address with a reverse discard route to the second router in a routing table.

15. An apparatus as recited in claim 11, wherein:
when executed, the logic is further operable for, before said determining whether communication with the successor neighbor router is interrupted, performing the steps of
determining whether the second cost equal is to the first cost, and
if it is determined that the second cost is equal to the first cost, then associating with the destination address an identifier for the second router and recovery data that indicates a possible loop free alternative during recovery; and
said determining whether the second cost is equal to the first cost if it is determined that the destination address is undergoing repair at the local router further comprises determining whether the recovery data associated with the destination address indicates a possible loop free alternative during recovery.
